(19) United States
(12) Patent Application Publication
(10) Pub. No.: US 2011/0219070 A1
(43) Pub. Date: Sep. 8, 2011

(54) Method and Apparatus for Social Networking

(76) Inventor: Santhosh Devati, Valley Village, CA (US)

(21) Appl. No.: 12/718,280

(22) Filed: Mar. 5, 2010

(51) Int. Cl. G06F 15/16; G06F 17/30; G06F 3/14

(52) U.S. Cl. 709/204; 707/769; 715/716; 715/864; 707/E17.014

(57) ABSTRACT

A system and apparatus facilitates social networking between service providers and customers displays provider profiles via a network. A provider window provides tabs that are expandable to provide more details about particular provider profiles without obscuring the screen view. The system enables searching of provider profiles and the search results utilizing predetermined criteria are presented. The search results are output as geometric shapes having various sizes, the sizes being indicative of a valued provider metric. In one embodiment of the invention, the geometric shapes include circles of various sizes and the valued provider metric is the popularity of the provider, wherein the most popular provider is associated with a circle of the largest size. The system also enables real-time communication between, a service provider and a customer via text, audio, video and calendar features.

### FIELD OF THE INVENTION

This invention pertains to on-line directories for service providers and particularly to social networking including service providers.

### BACKGROUND OF THE INVENTION

The Internet has allowed for great advancements in communication. People rely on searching the web and reading web pages for information about people, products and services. The information available is vast. Often a search engine search for a particular product or service will yield millions of hits. For the average consumer millions of hits are too much. People want Internet searches to yield a manageable amount of useful information.

When the Internet began, various pages provided simple textual information, and files for download. This allowed for a basic level of interaction between an Internet user and a web site. Now the Internet is more interactive. Web pages have TV programming, playable videos, games, pictures and audio. Information about web users is often communicated back to the web site in some form. Most web sites have some of these components. The level of interaction between web users and typical web sites is increasing.

The recent popularity of social networking web sites has enabled the Internet to reach the next level of interactivity, where users interact with each other by posting blogs, tweets, and personal information, images and videos. A popular website for social networking includes Facebook and a popular networking website is LinkedIn, for examples. These web sites provide valuable information about people and services, respectively. When viewing a person's profile, social interactions are typically accomplished by email, blogs or other textual communication.

Many web users are business people, who need to solve business problems. Often these users turn to the web to find a particular offering, i.e. a particularly skilled person, particular profile, or a particular product that can help them. Such web users first need to find the particular offering and then compare the alternatives. When questions about the offering and comparisons arise, an interview or a meeting may need to be scheduled. This all takes time, and the results are uncertain.

A social network that enables business people to interact with customers (including prospective customers) is needed to minimize searching effort via the Internet. It is also desirable to have a web portal that improves interaction between customers and business people to allow the customer to more easily search, find and compare offerings. It is further desired to have a social networking portal that improves ongoing communications between people, particularly between businesses and customers.

### SUMMARY OF THE INVENTION

The invention includes a computer and system to facilitate social networking, particularly networking that helps a user find professionals including health care professionals, legal professionals, accounting professionals, and specialists including personal trainers, nutritionists and others.

The computer includes a processor in communication with a memory having processor instructions, a database for storing a plurality of provider profiles, and display hardware. A computer program resides in the memory for connecting customers to provider profiles. The computer program includes instructions for causing the processor to access the database and display various tabs. The computer program searches the database for those provider profiles matching predetermined criteria. The computer program displays various tabs, one of such tabs being representative of provider profiles. The computer program enables actuation of the provider profile tab to present a window displaying image links to of various provider profiles.

The provider profile includes at least one communication toggle for initiating real-time communication between a customer and a provider. Particularly, the communication toggles include instant text pop-up window for communicating in instant text, an audio pop-up window to enable voice communication and a video pop-up window to facilitate video conferencing.

The present invention, in one embodiment, includes publishes an interactive web site that is designed to connect customers (including prospective customers) with service providers in a framework that can seed, nurture and grow a relationship. For a customer, the invention simplifies the process of finding, learning and engaging a service provider with confidence. Ideally a service provider promotes brands and services, educates customers respecting the services, engage the customers and offer the services and manage the services and relationship with customers. The interactivity of the web site is driven my offering multiple modes of real-time communication between the service provider and user.

The user benefits from the interactive web site because it enables the user to quickly search a database for a particularly defined service provider. Quickly learn about the service provider and its services, immediately engage the service provider by using any of a variety of instant communication modes and manage the services and relationship with the service provider.

### BRIEF DESCRIPTION OF THE DRAWINGS

The drawings illustrate particular aspects of the present invention where like parts have like reference numerals and wherein:

FIG. 1 is a system in accordance with the present invention.

FIG. 2 is a display window showing tabs in accordance with the present invention.

FIG. 3 is a display window showing an expanded tab in accordance with the present invention.

FIG. 4 is a display window showing a full window display of the expanded tab of FIG. 3.

FIG. 5 is a search result window showing various geometric figures representing search results.

FIG. 6 is a provider profile input screen that is divided into a profile input portion and a profile preview portion.

### DETAILED DESCRIPTION

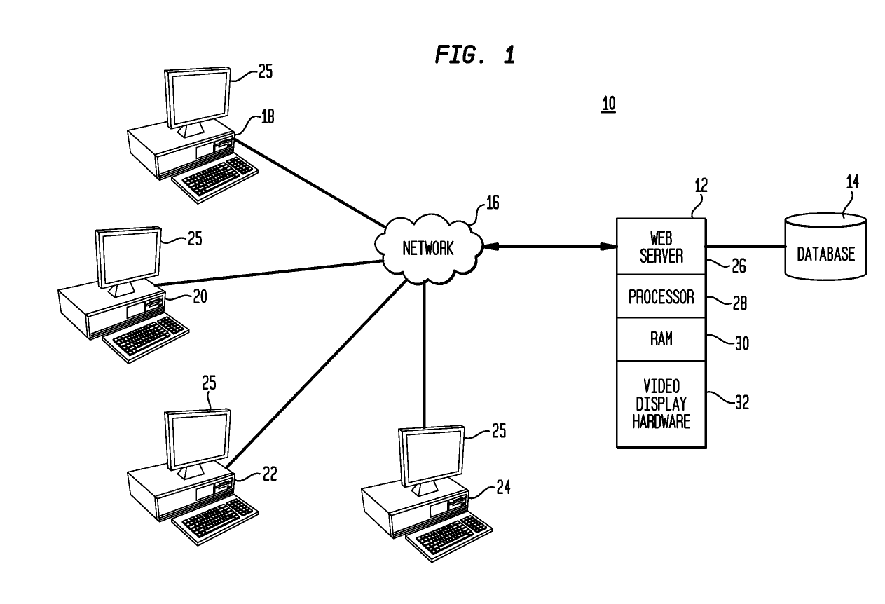

FIG. 1 shows a system 10 in accordance with the present invention. The system 10 includes a computer 12, a database 14, a network 16, and numerous clients 18, 20, 22 and 24. The system 10 publishes a web page to the network 16 and presents numerous profiles stored in the database 14 to network users, including the clients 18, 20, 22 and 24. Each client includes a display 25 for displaying provider profiles stored in the database 14.

The computer 12 includes a portion configured by software to function as a web server 26. The computer 12 includes hardware including a processor 28, random access memory 30 and video display hardware 32. The video display hardware 32 includes a video card and displays profiles stored in the database 14 via the web server 26 to clients 18, 20, 22 and 24.

The database 14 stores data characteristic of particular professionals including profession, skills, contact details, and special qualifications. The data 14 is presentable in the form of a professional provider profile.

The processor 28, random access memory 30 and video display hardware 32 are of the configuration and type found in most multi-purpose computers. The network 16 is the Internet in accordance to a preferred embodiment of the invention. The network 16 can include a virtual private network in another embodiment. The network 16 enables communication between the computer 12 and the clients 18, 20, 22 and 24 over any communication channel accessible by the clients 18, 20, 22 and 24.

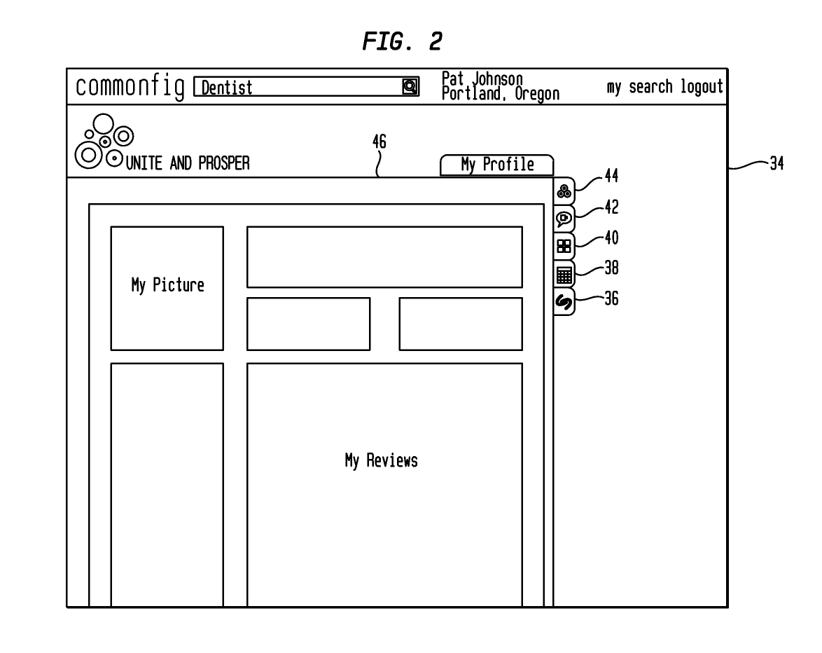

FIG. 2 shows a display window 34 having tabs 36, 38, 40, 42 and 44 in accordance with the present invention. The display window 34 includes a profile window 46, which is smaller than, and enclosed by the display window 34. The tabs 36, 38, 40, 42 and 44 are grouped adjacent one corner of the profile window 46 and extend peripherally from the profile window 46.

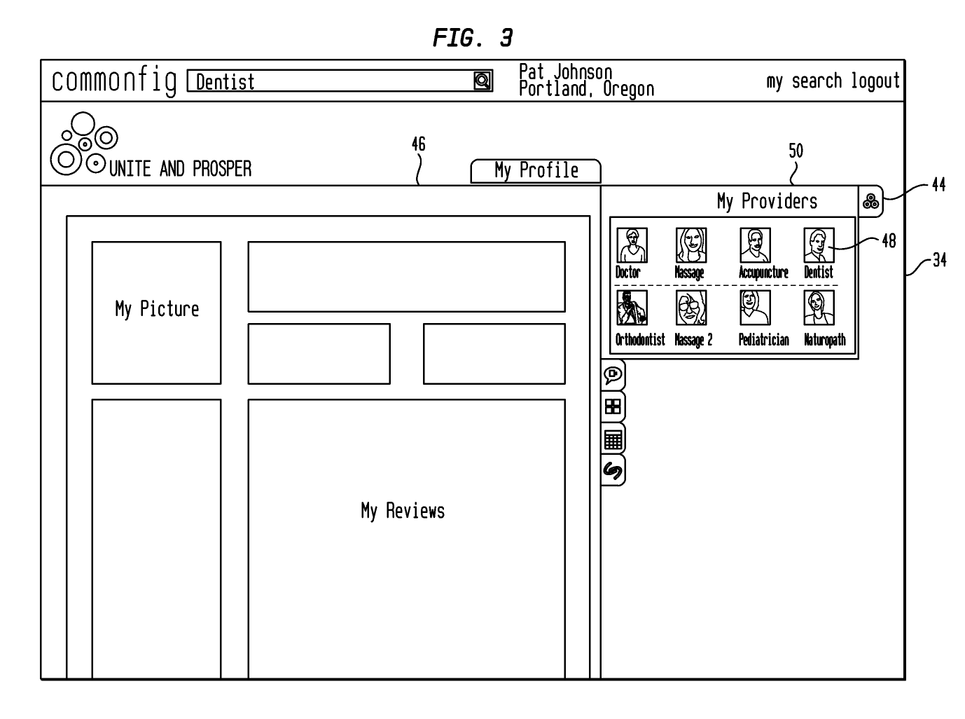

FIG. 3 shows tab 44 expanded from the profile window 46. Tab 44 is a provider profile tab. Tab 44 is shown actuated to display thumbnail images of provider profiles 48. Actuation of the tab 44, reveals a tab window 50 associated with tab 44. The tab window 50 expands the size of the tab 44, revealing the tab window 50, which occupies a portion of display window 34.

The display window 34 is sized to enclose the profile window 46. In one embodiment of the invention, the tab window 50 extends peripherally from the profile window 46, within the display window 34, and does not obscure the profile window 46. Activation of tab window 50 allows the tab window 50 and the profile window 46 to be viewed simultaneously, without obstruction. This feature, of having an extendable tab window 50, is particularly useful when the display window 34 is displayed on a touch-sensitive display. Touch sensitive displays are found on telephones, laptop computers, and electronic note-pad devices.

Tab window 50 displays thumbnail images, i.e. a photo, avatar or other representation of numerous provider profiles 48. Actuation of the tab window 50, further expands the view-ability of the provider profiles 48. Particularly, actuation of the tab window 50 expands the provider profiles to the size of the profile window 46.

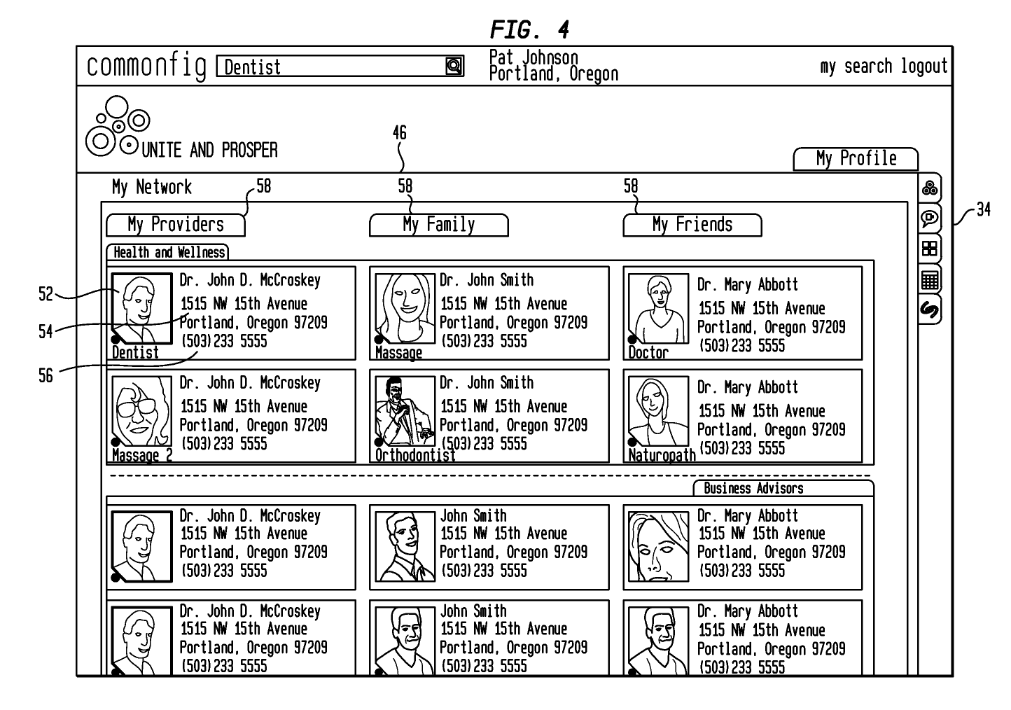

FIG. 4 shows display window 34 and the profile window 46. The profile window 46 displays the provider profiles 48, which have been stored in the database. Each provider profile 48 includes an enlarged thumbnail image 52, name and address block 54 and phone number 56 for each provider. Thus, a user can quickly access a directory of providers.

The profile window 46 includes category toggles 58 to facilitate focusing the profile window 46 on a selected category of profiles. For example, category toggles 58 includes a discrete toggle for “My Providers”, “My Family”, and “My Friends”, respectively. Actuation of one of the toggles 58 reveals providers, or individuals associated with the category of the toggle 58.

In proximity to the enlarged thumbnail image 52 of each provider profile 48 is text indicating the profession of the provider. Indicating a profession of the provider adjacent the enlarged thumbnail image 52 makes identifying the provider by profession a rapid task.

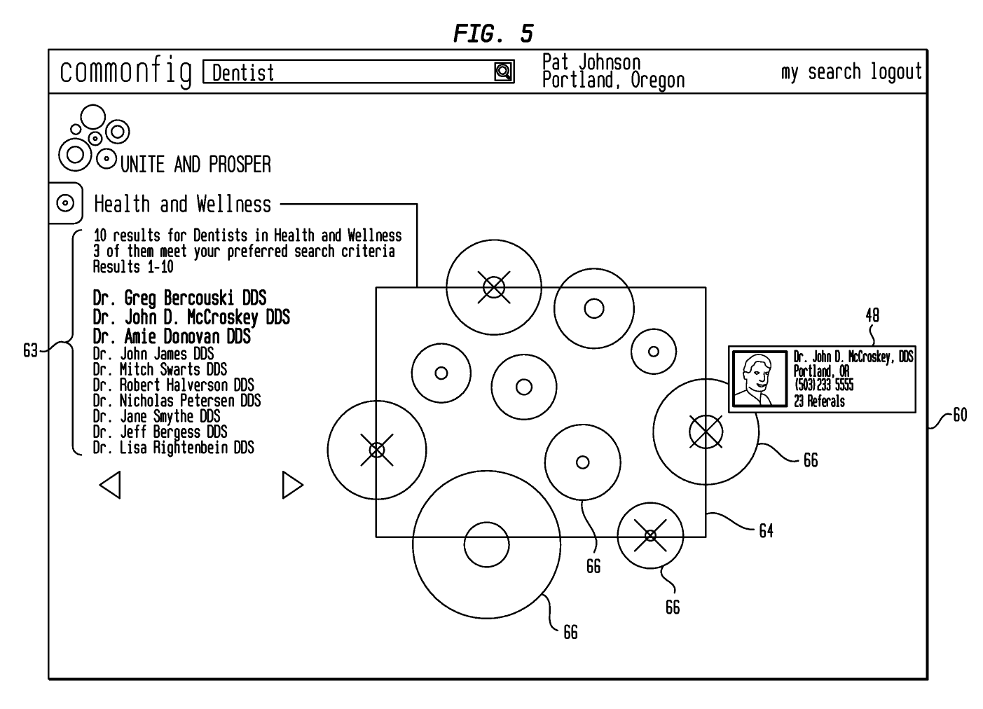

FIG. 5 shows a search result window 60. The search result window 60 displays textual search results 62 and graphical search results 64. The graphical search results 64 include graphical shapes 66 of various sizes. Passing a cursor over the relevant shape 66 reveals at least one provider profile 48. The size of each geographical shape 66 is indicative of a pre-determined quality of the provider represented by the provider profile 48. Preferably, one quality of a provider is size of that providers business, another quality is the frequency of use of that provider by users. Other qualities that can be used include price for services or proximity with respect to a particular.

In an alternate embodiment, the graphical search results yield various geographical shapes 66 including triangles, squares, rectangles, rhomboids, and other multilateral shapes. In such an embodiment, the shape is indicative of a pre-determined quality of the provider represented by the provider profile.

In yet another embodiment, the graphical search results yield geographical shapes 66 having various color shades, each shape being a different color than another shape. In such an embodiment, the color of the geographical shape being indicative of a pre-determined quality of the provider represented by the provider profile.

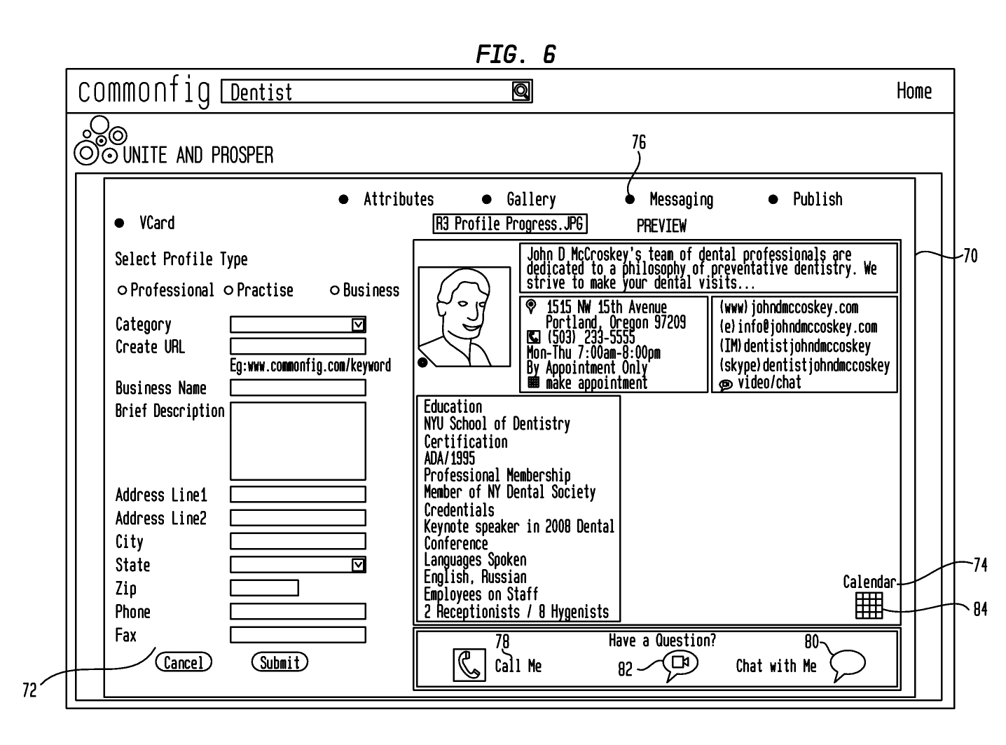

FIG. 6 is a display window 34 including a provider profile input window 70 that is divided into a profile input portion 72 and a profile preview portion 74. Entry of data into the input portion 72 instantly modifies the profile preview portion 74 to enable a user to see what any resulting provider profile will look like as data is being entered.

The preview portion 74 of the display window 34 displays several communications toggles including a messaging communications toggle 76, an audio communications toggle 78, a video conference communication toggle 82 and a chat communications toggle 80. The preview portion 74 also includes a calendar toggle 84, for displaying a pop-up calendar that enables real-time scheduling of appointments. The preview portion 74 represents relevant provider profile.

Each communications toggle activates a communications pop-up window to enable real-time communication between a customer and a provider. Communications toggle 78 enables and activates an audio communication pop-up window. Communication toggle 82 enables and activates a video pop-up window. Communication toggle 80 enables and activates an instant text pop-up window.

While the present invention is described with reference to a preferred embodiment, it can be appreciated that modifications to the preferred embodiment are expected and such modifications are intended to be covered by the scope of the invention as defined by the appended claims.

What is claimed is:

1. A computer to facilitate social networking, comprising:
a processor in communication with a memory having processor instructions, a database for storing a plurality of provider profiles, and a display;
a computer program residing in the memory for connecting customers to provider profiles, the computer program including instructions for causing the processor to:
access the database to search the database for those provider profiles matching predetermined criteria;
display various tabs, one of such tabs being representative of provider profiles; and
enabling actuation of said provider profile tab to present a window displaying image links to various provider profiles.

2. An apparatus as set forth in claim 1, wherein each provider profile includes a communication toggle for initiating real-time communication between a customer and a provider.

3. An apparatus as set forth in claim 1, wherein each provider profile includes a calendar toggle for initiating real-time scheduling between a customer and a provider.

4. An apparatus as set forth in claim 2, wherein the communication toggle enables activation of an instant text communication pop-up window.

5. An apparatus as set forth in claim 2, wherein the communication toggle enables activation of an audio communication pop-up window.

6. An apparatus as set forth in claim 1, wherein one of the toggles enables activation of a video pop-up window.

7. A computer to facilitate social networking, comprising:
a processor in communication with a memory having processor instructions, a database for storing a plurality of provider profiles, and a display;
a computer program residing in the memory for connecting customers to provider profiles, the computer program including instructions for causing the processor to:
access the database to search the database for those provider profiles matching predetermined criteria including a valued provider metric; and
display search results with the display, the search results being representative of the predetermined criteria, the search results being presented as geometric shapes having various sizes, the sizes being indicative of a valued provider metric.

8. An apparatus as set forth in claim 7, wherein the geometric shapes include circles of various sizes and the valued provider metric is the popularity of the provider, wherein the most popular provider is associated with a circle of the largest size.

9. An apparatus as set forth in claim 7, wherein each provider profile includes a calendar toggle for initiating real-time scheduling between a customer and a provider.

10. An apparatus as set forth in claim 7, wherein each provider profile includes a communication toggle for initiating real-time communication between a customer and a provider, the communication toggle enables activation of an instant text communication pop-up window.

11. An apparatus as set forth in claim 7, wherein each provider profile includes a communication toggle for initiating real-time communication between a customer and a provider, the communication toggle enables activation of an audio communication pop-up window.

12. An apparatus as set forth in claim 7, wherein each provider profile includes a communication toggle for initiating real-time communication between a customer and a provider, the communication toggle enables activation of a video pop-up window.

13. A computer system to facilitate input of a provider profile for social networking, comprising:
a processor in communication with a memory having processor instructions, a database for storing a plurality of provider profiles, and a display;
a computer program residing in the memory for connecting customers to provider profiles, the computer program including instructions for causing the processor to:
access the database to enable the database to receive input and search the database;
display an input screen to receive input data characteristic of a provider profile from a user, and simultaneously display an input screen preview to enable the user to instantly see how the provider profile looks as input data is received.

14. An apparatus as set forth in claim 13, wherein the computer system and the display communicate via a network.

15. An apparatus as set forth in claim 13, wherein the computer system and the display communicate via a network and the display is a hand-held device.

16. A computer-implemented method to facilitate social networking, comprising:
a multi-purpose computer having a memory and a computer program residing in the memory for connecting customers to provider profiles, the computer program including instructions for causing the processor to:
access the database to search the database for those provider profiles matching predetermined criteria including a valued provider metric; and
display search results with the display, the search results being representative of the predetermined criteria, the search results being presented as geometric shapes having various sizes, the sizes being indicative of a valued provider metric.

17. A method as set forth in claim 16, further comprising providing geometric shapes including circles of various sizes and the valued provider metric is the popularity of the provider, wherein the most popular provider is associated with a circle of the largest size.

18. A method as set forth in claim 16, further comprising providing a calendar toggle for initiating real-time scheduling between a customer and a provider.

19. A method as set forth in claim 16, further comprising providing communication toggle for initiating real-time communication between a customer and a provider, the communication toggle enables activation of an audio communication pop-up window.

20. A method as set forth in claim 16, further comprising providing a communication toggle for initiating real-time communication between a customer and a provider, the communication toggle enables activation of a video pop-up window.
